(19) United States
(12) Patent Application Publication
(10) Pub. No.: US 2005/0092777 A1
(43) Pub. Date: May 5, 2005

(54) Container with a draw device

(76) Inventor: Yu-Fa Wu, Pusin Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/698,445

(22) Filed: Nov. 3, 2003

(51) Int. Cl. B67D 5/40

(52) U.S. Cl. 222/382

(57) ABSTRACT

A container includes a body having a containing space defined therein and a close bottom that is tapered relative to a center thereof and has a dimple defined in the center of the close bottom so that the remained liquid in the body is guided and flows into the dimple. A draw device is mounted to a top of the body. The draw device includes a drawing tube extending into the body and having a distal end separately received in the dimple. An inlet is defined in the distal end of the drawing tube for drawing the liquid in the dimple. A seat is securely attached to the close bottom of the body for perpendicularly standing the body on a supporting surface.

### BACKGROUND OF THE INVENTION

1. Field of the Invention

The present invention relates to a container with a draw device, and more particularly to a container with a draw device, wherein a dimple is defined in a bottom of the container to allow an inhale tube extending into the dimple for reducing the remained liquid.

2. Description of Related Art

A conventional container with a draw device in accordance with the prior art shown in FIGS. 4 and 5 comprises a body (5) including a close bottom (51) for containing liquid (7) in the body (1) and a draw device (6) is mounted to the top of the body (5) for drawing the liquid (7) out of the body (5). The draw device (6) includes a drawing tube (61) longitudinally extending into the body (5) to the bottom (51) of the body (5). For reducing the remained liquid, the distal end (62) of the drawing tube (61) is designed to be slant.

However, the liquid (7) in the body (5) cannot be fully drawn out of the body (5) and always some liquid is lastly remained on the bottom of the body (5). The user needs to detach the draw device (6) for pouring out the remained liquid. With reference to FIG. 6, for standing the body (5), the bottom (51) of the body (5) is design as a plane so that draw device (6) cannot draw the liquid (7) from the body (5) when the level of the liquid (7) in the body (5) is lower than a height of the slant distal end (62) of the drawing tube (61) and the volume of the remained liquid are the product of the height of the slant distal end (62) and the area of the close bottom (51) of the body (5). Consequently, the amount of the remained liquid is considerable.

The present invention has arisen to mitigate and/or obviate the disadvantages of the conventional container with a draw device.

### SUMMARY OF THE INVENTION

The main objective of the present invention is to provide an improved container with a draw device that can greatly reduce the amount of remained liquid in the container.

To achieve the objective, container with a draw device in accordance with the present invention comprises a container including a body having a containing space defined therein and a close bottom that is tapered relative to a center thereof and has a dimple defined in the center of the close bottom so that the remained liquid in the body is guided and flows into the dimple. The draw device is mounted to a top of the body. The draw device includes a drawing tube extending into the body and having a distal end separately received in the dimple. An inlet is defined in the distal end of the drawing tube for drawing the liquid in the dimple. A seat is securely attached to the close bottom of the body for perpendicularly standing the body on a supporting surface.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a container with a draw device in accordance with the present invention;

FIG. 2 is a side plan view in partial section of a container with a draw device in accordance with the present invention;

FIG. 3 is a partially cross-sectional view of the container in FIG. 2;

FIG. 4 is a perspective view of a conventional container with a draw device in accordance with the prior art;

FIG. 5 is a partially cross-sectional view of the container in FIG. 4; and

FIG. 6 is a partially enlarged view of FIG. 5.

### DETAILED DESCRIPTION OF THE INVENTION

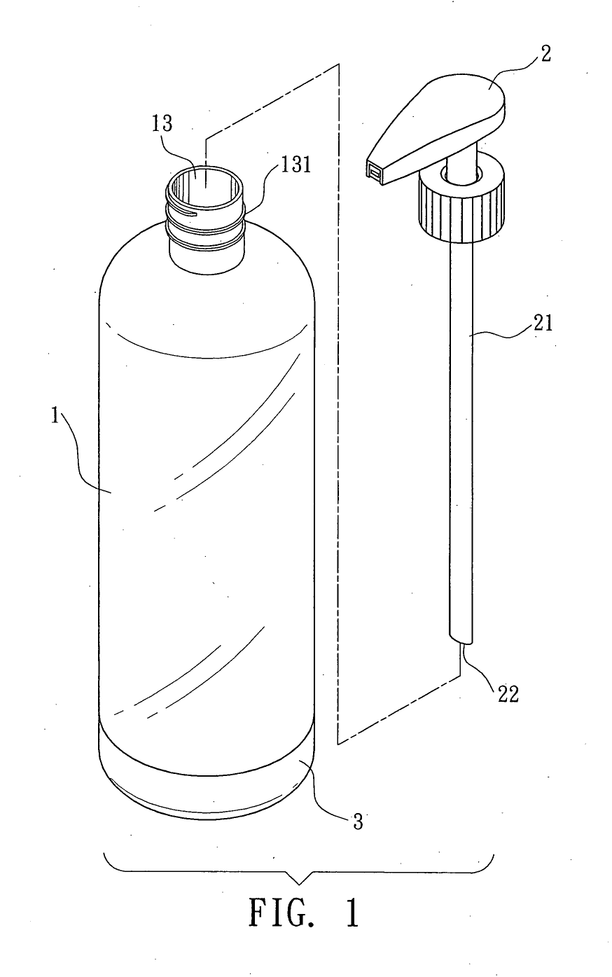

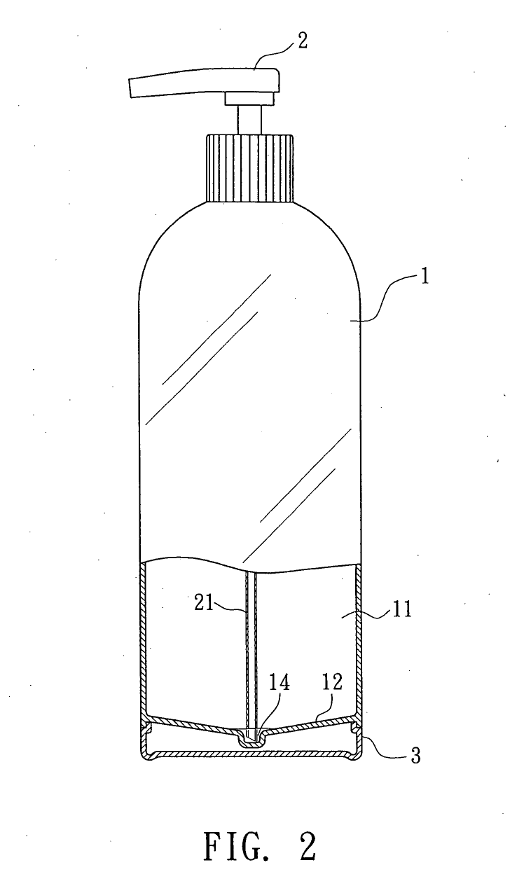

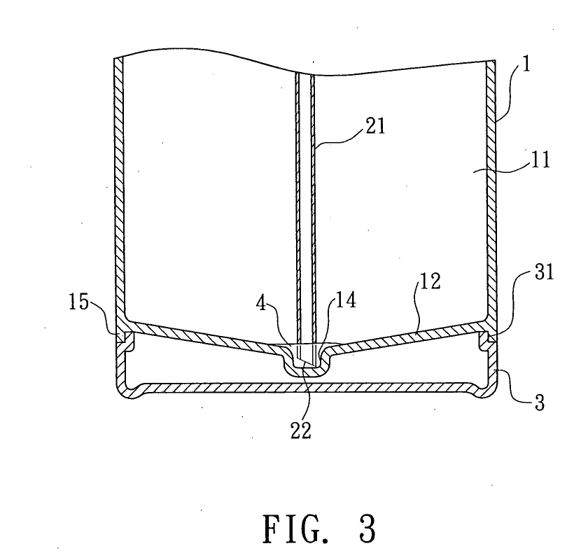

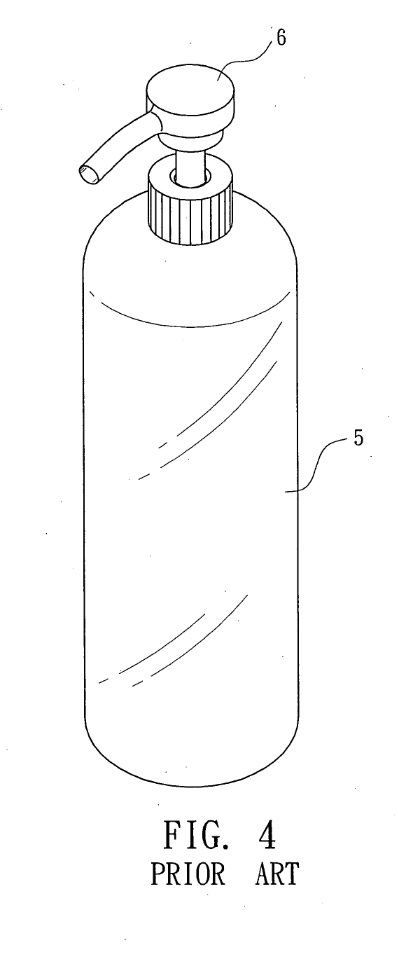

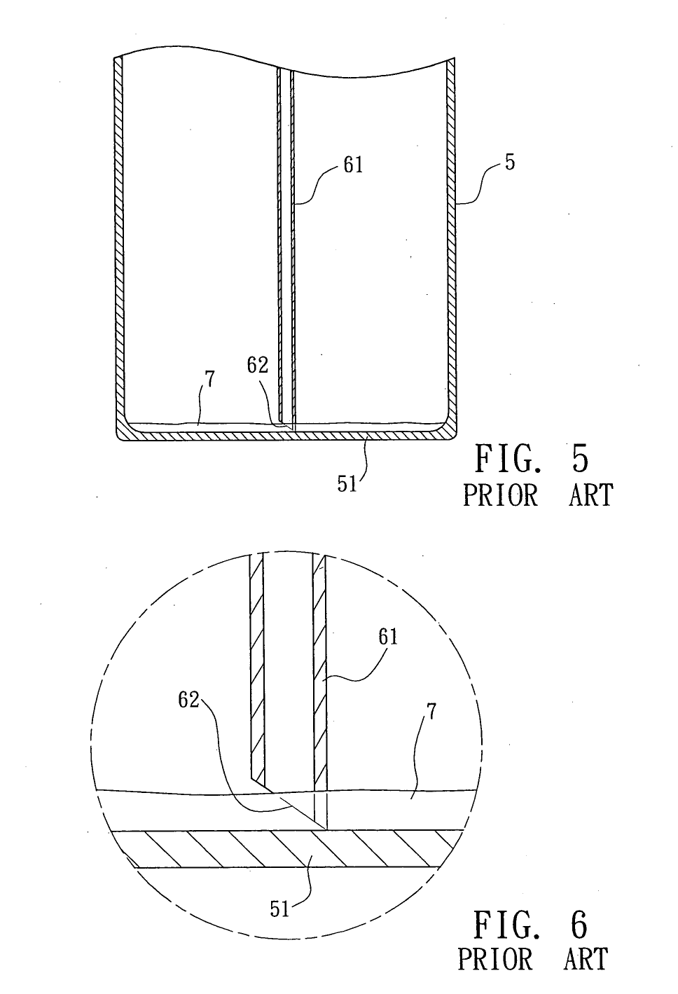

Referring to the drawings and initially to FIGS. 1-3, a container with a draw device in accordance with the present invention comprises a body (1) and a containing space (11) is defined in the body (1). The body (1) has a close bottom (12), and a hollow stub (13) extending therefrom and communicating with the containing space (11). The close bottom (12) of the body (1) is tapered relative to a center thereof and a dimple (14) is centrally defined in the close bottom of the body (1) the tapered closed bottom can guide the liquid (4) flowing into the dimple (14). A protrusion (15) downward extends from the close bottom (12).

A seat (3) is securely attached to the close bottom (12) of the body (1) for perpendicularly standing the body (1) on a supporting surface. The seat (3) has an annular cutout (31) defined in a top thereof for receiving the protrusion (15) of the body (1).

The draw device (2) is mounted on the top of the body (1). In the preferred embodiment of the present invention, the draw device (2) is screwed onto the threaded outer periphery (131) of the hollow stub (13). The draw device (2) includes a drawing tube (21) extending into the body (1) and having an inlet (22) defined in a distal end of the drawing tube (21). The drawing tube (21) has a diameter smaller than that of the dimple so that the inlet (22) is slant and separately received in the dimple (14) in the close bottom (12) of the body (1) for drawing the liquid (4) that flows into the dimple (14).

As described above, the remained liquid (4) is guided and flows into the dimple (14) in the close bottom (12) of the body (1). Consequently, the container in accordance with the present invention can greatly reduce the amount of the remained liquid (4) in the body (1).

Although the invention has been explained in relation to its preferred embodiment, it is to be understood that many other possible modifications and variations can be made without departing from the spirit and scope of the invention as hereinafter claimed.

1. A container with a draw device, comprising:
a body including a containing space defined therein and a close bottom, the close bottom being tapered relative to a center thereof and having a dimple defined in the center of the close bottom so that the remained liquid in the body is guided and flows into the dimple;
the draw device mounted to a top of the body, the draw device including a drawing tube extending into the body and having a diameter smaller than that of the dimple, the drawing tube having a distal end separately received in the dimple due to the smaller diameter of the drawing tube relative to the dimple, an inlet defined in the distal end of the drawing tube for drawing the liquid in the dimple; and
a seat securely attached to the close bottom of the body for perpendicularly standing the body on a supporting surface.

2. The container as claimed in claim 1, wherein the body comprises a protrusion downward extending from the close bottom of the body and the seat comprises an annular cutout defined to receive the protrusion of the body.

3. The contained as claimed in claim 1, wherein the body comprises a hollow stub extending therefrom and communicating with the containing space in the body, the hollow stub having a threaded outer periphery and the draw device being screwed onto the threaded outer periphery of the hollow stub.

4. The container as claimed in claim 1, wherein the inlet of the draw device is slant for drawing the liquid that flows into the dimple.

5. The contained as claimed in claim 2, wherein the body comprises a hollow stub extending therefrom and communicating with the containing space in the body, the hollow stub having a threaded outer periphery and the draw device being screwed onto the threaded outer periphery of the hollow stub.

6. The container as claimed in claim 2, wherein the inlet of the draw device is slant for drawing the liquid that flows into the dimple.

7. The container as claimed in claim 3, wherein the inlet of the draw device is slant for drawing the liquid that flows into the dimple.
